(19) United States
(12) Patent Application Publication
(10) Pub. No.: US 2005/0175780 A1
(43) Pub. Date: Aug. 11, 2005

(54) Acidic solution for silver deposition and method for silver layer deposition on metal surfaces

(75) Inventors: Christian Sparing, Berlin (DE); Hartmut Mahlkow, Berlin (DE)

Correspondence Address: PAUL AND PAUL, 2900 TWO THOUSAND MARKET STREET, PHILADELPHIA, PA, 19103, US

(73) Assignee: Atotech Deutschland GmbH, Berlin (DE)

(21) Appl. No.: 10/513,250

(22) PCT Filed: May 27, 2003
(86) PCT No.: PCT/EP03/05585

(30) Foreign Application Priority Data
Jun. 11, 2002 (DE) 102 26 328.0

(51) Int. Cl. B05D 3/04; B05D 1/18; C23C 18/31

(52) U.S. Cl. 427/307; 427/430.1; 106/1.19; 106/1.23

(57) ABSTRACT

A processing solution and a method are used for producing solderable and bondable silver layers that properties of which are not degraded even after storing, with no anti-tarnishing compounds being utilized as contrasted with prior art solutions and methods. The acidic solution for silver deposition contains silver ions and at least one Cu(I) complexing agent, said Cu(I) complexing agent being selected from the group consisting of having the structure element (I).

The invention relates to an acidic solution for silver deposition through charge transfer reaction and to a method for silver layer deposition on metal surfaces through charge transfer reaction, more specifically for manufacturing printed circuit boards and other circuit carriers.

In manufacturing printed circuit boards and other circuit carriers, the non-conductive surfaces of the substrates are generally at first clad allover with a copper layer for the purpose of making the surfaces conductive. Usually, the non-conductive walls of the holes in the substrates are thereby metal-plated for the first time. Next, conductive patterns are formed on the surfaces of the substrate. Various methods may be utilized for this purpose. A current method consists in first depositing on the surfaces a mask formed with a photosensitive film, said mask only covering those areas of the surfaces that are not to be provided with a pattern and leaving those corresponding to the conductive patterns uncovered. A copper layer is then deposited in these areas using an electrolytic method, the thickness of said copper layer corresponding to that of the conductive patterns to be formed. Then, a further metal layer, a tin layer for example, is electrolytically applied onto the copper layer formed, said further metal layer serving as an etch protection during the subsequent patterning process. Then, the mask is removed from the surfaces and the exposed copper is removed by etching off the areas which do not correspond to the conductive pattern. Finally, the metal layer that forms the etch protection coating is also removed so that the conductive patterns are obtained.

For electrically attaching components such as resistors, capacitors and semiconductor components, a solder layer consisting of an alloy of tin and lead is applied to the deoxidized copper surfaces using liquid solder, excess liquid solder being removed from the surfaces, and more specifically from the holes, by means of a hot air jet (air knife). This method is known by the name of hot air leveling (HAL process). In most cases, HAL is only performed after deposition of a solder resist mask which consists of a polymer film and is applied to the surfaces of the printed circuit board except for those areas in which the components are intended to be soldered. As a result, the liquid solder only covers those sites on the printed circuit boards with which the components are intended to make electrical contact.

After the tin/lead-alloy layer is formed, the components may be either mounted “through-the-stack” or surface mounted onto the printed circuit board where they are soldered. As it often happens that the components are mounted and soldered a fairly long time after production of the circuit structures on the printed circuit boards only, the copper surfaces oxidize so that their ability to be wetted by liquid solder is extremely reduced. Accordingly, the circuit structures should be freed from the oxide layers formed prior to soldering. In forming the tin/lead-alloy layer on the circuit structures, the latter are prevented from oxidizing so that the components may be mounted and soldered at a later stage without any problem. Accordingly, the layers produced with the HAL process also serve to protect the copper surfaces from progressive oxidation. As a result thereof, areas prepared with the HAL process are very easy to solder. Furthermore, the surfaces of the printed circuit boards resist oxidation and other corrosive processes.

Although thickness uniformity of the tin/lead-alloy layer may be achieved in carrying out the HAL process by means of the air knife, considerable thickness differences remain on the surfaces of the printed circuit boards. As the circuit density increases and automatic mounting of the components is being introduced, the conductive patterns must be formed with surfaces as planar as possible, which is not possible with the HAL process. Also, as the distances between the connecting pads for the components diminish, solder bridge formation occurs more frequently. Therefore, alternative methods have been sought to replace HAL process and to avoid thus the disadvantages of the tin/lead-alloy layers formed on the copper surfaces. A primary object is to prevent oxidation of the copper surfaces and concurrently to meet the demands resulting from the ever-increasing miniaturization and automation of the mounting procedure.

One approach to mitigate these problems consists in forming a combined layer of nickel and gold. As the circuit structures to be coated are generally electrically insulated from each other, the two metal layers are electroless plated to the copper surfaces. In using electroless plating, it is not necessary to connect electrically the areas of the copper surfaces that are to be plated to an external power source.

The nickel-gold final layer is particularly suited for applications that have to meet highest quality requirements. It is both solderable and bondable and provides excellent protection against corrosion. It may furthermore be utilized to produce electrical contact areas, in switches and plug contacts for example. This technique is very expensive though, so that its application is limited to high-quality circuits. It is not suited for mass application.

Another high-quality end surface is formed by electroless plating the copper surfaces with palladium. Best solderability may be achieved with a palladium layer of 0.2 μm thick deposited on copper. Furthermore, the palladium-surfaces are also suited to produce contact areas on the printed circuit boards because of their reduced contact resistance. Due to the high price of palladium, its use in mass production must be excluded, though.

The formation of an organic protective layer consisting of alkyl imidazoles or alkyl benzimidazoles on the copper areas is much cheaper than a coating made of the combined layer of nickel and gold or of palladium. These protective layers provide effective tarnish resistance, thus preventing the copper surfaces from oxidizing. They are moreover very thin so that the disadvantages due to the irregular thickness distribution of the HAL layers are avoided.

A disadvantage thereof however is that the organic protective layers mentioned are not fully suited to bond unhoused semiconductor components that are placed directly onto the printed circuit boards. Moreover, it is not possible to solder one more time a printed circuit board that has already been subjected to a soldering process as the protective layer is destroyed during the first soldering operation. Also, the advantage of the nickel-gold combined layer and of the palladium layer that permit to form electrical contact areas on the printed circuit boards cannot be realized with the organic protective layers.

Another alternative method is to electroless tin-plate the copper surfaces of the circuit structures by charge transfer with the copper. But, just as the organic protective layers, the tin layers provide but a small tarnish resistance. Furthermore, they do not allow to produce multifunctional surfaces since it is not possible to make electrical contacts with tin surfaces. The solderability of the tin layers is given since the tin layer also provides tarnish resistance. Multiple soldering steps however are only possible under certain conditions. Furthermore, it is not possible to produce contact layers for switches and plug contacts.

The known methods are utilized depending on the requirements to be expected. For manufacturing simple printed circuit boards, a final layer only, which is suited for soldering applications, is for example formed. The HAL process will do for this purpose. If high-quality printed circuit boards are to be manufactured which are intended to both be suited for bonding applications and have electrical contact areas, a nickel-gold combined layer or a layer of palladium is applied.

Silver-plating involves costs that may be compared to tin-plating. With but small thicknesses a final silver layer on copper already meets many conditions of a modern final layer. More specifically, silver layers may not only utilized for soldering applications but for bonding applications as well. Furthermore, these layers also have a very low contact resistance so that they may also be utilized to form plug contacts on printed circuit boards and switches.

A method of coating leadframes and other electronic components with silver is described in U.S. Pat. No. 5,194,139. The method disclosed therein is directed to the pre-treatment of substrates coated with a thin film of copper prior to silver deposition through charge transfer reaction for the purpose of providing silver with high bond strength. The pre-treating solution is acidic and contains cyclic compounds the rings thereof including a thioureylene radical of the general formula —N(R¹)—C(S)—N(R²)—, wherein R¹ and R² may be each hydrogen, an alkyl group or an allyl group. According to this document, examples of these compounds include 2-imidazolidinethione, barbituric acid, 2-thiobarbituric acid, 1-allyl-2-thiourea, 1-phenyl-2-tetrazolin-5-thione, 2-thiourasil, 4-thiouramil, and their derivatives.

The known methods for depositing silver onto copper are based on the so-called charge transfer method according to equation A:
Cu+2 Ag⁺→Cu²⁺+2 Ag A

The silver layer can be about 0.2 μm thick. It protects the copper from oxidation. The silver surface furthermore allows multiple soldering steps. The layer is planar and is also suited for press-fit securement by which the connecting pins of electrical components are mechanically pressed into the holes provided in the printed circuit board in an effort to make an electrical contact with the circuit structures. Even after ageing heat and vapor treatment of a printed circuit board provided with silver surfaces, the results as to solderability could be compared to those of a classical HAL surface.

A plurality of methods of producing silver layers on copper surfaces have been published:

In J. Electrochem. Soc. India (1967), volume 16, pages 85-89, various aqueous baths for forming tightly adherent and uniform silver layers on copper surfaces are compared. The baths contain ammonia, silver nitrate and sodium thiosulfate. An aqueous bath containing silver bromide, sodium thiosulfate and sodium hypophosphite was also tested. According to this document, a dark tarnishing of the layers deposited from these baths was observed to occur soon.

U.S. Pat. No. 3,294,578 describes a method of electroless silver plating a metallic surface, such as aluminum, utilizing a solution of a silver complex with complexing agents in the form of nitrogen containing compounds. The complexing agents suggested therein include, among others, pyrrolidone, for example N-methylpyrrolidone, amides, for example di methyl form amide, anilines and amines.

The solderability of the silver layers produced proved still insufficient after storage. Therefore, various suggestions have been made to provide the silver layers with an anti-tarnish:

Electroplating and Metal Finishing (1963), pages 336-342 suggests for example to chromate the silver layers in order to, inter alia, enhance their solderability after storage. Klein-Wassink's book “Soldering in Electronics” (“Weichlöten in der Elektronik”) (1986), pages 191-192, mentions that the solderability of silver coatings is improved by means of an organic protective layer, through chromate passivation or by applying mercaptans.

DE-OS 21 16 012 describes a method for the surface treatment of metals that are to be soldered. For this purpose, an agent containing at least one imidazole derivative is applied. Although this document is substantially directed to the surface treatment of copper or the alloys thereof, it mentions in an example, among others, the treatment of silver as a preparatory treatment prior to soldering.

EP 0 797 690 B1 describes a method for plating a printed circuit board by applying onto the copper areas a layer of silver by way of charge transfer. The silver bath may contain, i.a., anti-tarnishing agents for the purpose of ensuring solderability post storing. In addition to the silver compounds and the anti-tarnishing agents, the bath also contains, among others, complexing agents, more specifically amino acids and the salts thereof, polycarboxylic acids, more specifically amino acetic acids, crown ethers and/or cryptands. The document mentions by way of example the following anti-tarnishing agents: fatty acid amines, purines, N-acyl derivatives of sarcosine, organic polycarboxylic acids, imidazoline, alkyl imidazole or alkyl benzyl imidazole, benzimidazole, phosphate ester, triazole derivatives, more specifically benzotriazole as well as substituted tetrazoles.

EP 0 797 380 A1 discloses a method for enhancing the solderability of copper surfaces, more specifically of printed circuit boards, in which a silver layer is applied to the surfaces by charge transfer prior to soldering. The silver layer is formed by contacting the surfaces with an acidic plating solution containing a silver imidazole complex. The preferred source of silver ions used is silver nitrate.

U.S. Pat. No. 5,733,599 describes a method for enhancing the solderability of a surface in which a copper-plated printed circuit board material is at first coated with a layer of silver by a charge transfer reaction, another metal layer being applied to said layer of silver, said metal being selected from the group consisting of gold, ruthenium, rhodium and palladium. The silver plating solution preferably contains silver nitrate, methane sulfonic acid and histidine in order to achieve enhanced solderability of the surfaces.

U.S. Pat. No. 5,935,640 also describes a method for enhancing the solderability of a surface in which the copper surfaces of a printed circuit board are at first coated with a silver layer by a charge transfer reaction. The solution used for forming the silver layer contains, among others, silver nitrate, methane sulfonic acid and an imidazole or a derivative thereof.

U.S. Pat. No. 6,200,451 describes another method for enhancing the solderability of a metallic surface, a silver layer being at first deposited by a charge transfer reaction onto the copper surfaces of a printed circuit board material. The solution used for forming the silver layer contains, among others, silver nitrate, an acid and an additive, selected from the group consisting of fatty amines, fatty amides, quaternary salts, amphoteric salts, resinous amines, resinous amides, fatty acids, resinous acids and possibly imidazole, benzimidazole or derivatives of imidazole.

EP 0 795 043 B1 describes a method of manufacturing a protective coating of silver on a substrate having a metal surface, said substrate with the metal surface preferably being copper clad printed circuit board material. To obtain the silver layer, a silver plating bath is used that relies on a charge transfer reaction and that contains, among others, silver nitrate and a multidentate complexing agent such as an amino acid, a polycarboxylic acid, a crown ether and/or a cryptand as well as an anti-tarnishing agent. The anti-tarnishing agents mentioned are an ethoxylated alkyl amine and triazole derivatives.

In Patent Abstracts of Japan regarding JP 03-002379 A there is described a method of forming a layer of silver on copper, the plating bath containing, in addition to silver nitrate, an alkyl imidazole compound and an organic acid or the salt thereof.

In Patent Abstracts of Japan regarding JP 06-299375 A there is furthermore described a processing method for metallic surfaces in which silver is i.a., coated with a chemical conversion layer in order to achieve improved resistance against humidity, chemical influences and action of heat, thus enhancing the solder properties. To form the chemical conversion layer, the silver surface is contacted with an aqueous solution containing a derivative of imidazole.

The known methods for enhancing the solderability on copper surfaces present the following disadvantages:

The thickness of the outer layers formed to enhance solderability is often not uniform. Furthermore, it may be very expensive to produce such layers, particularly in the case of a nickel-gold or a palladium layer. In some cases, constituents are used in their production that have a serious impact on the environment like e.g., solutions containing chromium (VI). In many cases, the layers formed are not suited to make bond connections and electrical contacts.

To overcome these drawbacks, DE 100 50 862 A1 suggests to utilize a bath and a method for electroless silver-plating surfaces made of a metal less noble than silver by a charge transfer reaction, more specifically on copper. The bath contains at least one silver halogen complex but no reducing agent for silver ions. The silver halogen complex is the silver bromine complex of preference. However, the bath described in this document has the disadvantage that benzotriazole compounds must be added in order to achieve good soldering results. The benzotriazole compounds serve primarily to protect the silver layer obtained from oxidation and from the risk of corrosion products forming from the atmosphere in the form of silver-sulfur compounds for example. After a short period of operation of the bath, the silver layers produced were slightly yellowish and had no longer the white silver color they had when the bath was freshly prepared. This discoloration of the silver layer increases after an ageing treatment with dry heat (4 hours, 155° C.) and with a vapor test (4 hours, 100° C.) and is considered to be responsible for the strong reduction in solder wetting of the silver layer.

The drawback of all the known methods utilizing the anti-tarnishing compounds mentioned is that these agents are generally to be utilized in relative high concentrations in order to become effective and that, as a rule, these agents have an impact on the environment. It furthermore proved disadvantageous that in these cases the silver layers formed are provided with a relatively rough surface due to dendrites.

It is therefore the object of the present invention to avoid the drawbacks mentioned and to more specifically provide a bath and a method of silver deposition by way of a charge transfer reaction (immersion plating) that permits to form silver layers that exhibit properties of good solderability, tight adhesion, and that are possibly bondable and non-porous without the already mentioned anti-tarnish compounds having to be utilized so that the method can be carried out under conditions that have less impact on the environment. Further, the silver layers are intended to have a smooth surface without dendrites.

The solution to this object is achieved by the acidic solution for silver deposition by means of a charge transfer reaction according to claim 1 and by the method of depositing silver layers onto metal surfaces by way of a charge transfer reaction according to claim 11. Preferred embodiments of the invention are recited in the subordinate claims.

Before the present invention of providing an acidic solution for silver deposition and a method of depositing silver layers is disclosed and described, it is to be understood that this invention is not limited to the particular process steps and materials disclosed herein as such process steps and materials may vary somewhat. It is also to be understood that the terminology used herein is used for the purpose of describing particular embodiments only and is not intended to be limiting since the scope of the present invention will be limited only by the appended claims.

The acidic bath of the invention and the method of the invention are suitable for electroless silver plating surfaces made from a metal that is less noble than silver, more specifically surfaces made from copper, by means of a charge transfer reaction. This means that the bath preferably does not contain any reducing agent. In this case, silver is exclusively, or at least mainly, reduced and deposited by means of a charge transfer reaction with the metal to be coated. The silver ions contained in the bath, preferably silver(I) ions, are reduced to metallic silver while the metal to be coated, copper for example, is simultaneously oxidized according to the reaction of equation A given herein above and is dissolved in the process. The metal surface to be plated is coated with a silver layer until the metal surface is covered with a continuous, non-porous layer of silver. As soon as such a layer is achieved, the metal to be plated is no longer contacted with silver ions so that the redox reaction ends.

More specifically, the acidic solution and the method can be advantageously utilized for manufacturing printed circuit boards. In this case, silver is deposited onto the copper surfaces of the printed circuit board material. It goes without saying that other applications are possible, for example in silver plating for decorative purposes or in the manufacturing of coatings having the features of extremely high electric conductivity like in wave guides for example.

Accordingly, the method of the invention more specifically serves to form protective silver layers on copper surfaces, on printed circuit boards in particular, to subsequently perform a soldering process, a bonding process, a press-fit securement and/or to establish electrical contacts. The invention is more specifically directed to producing pure silver layers.

The acidic solution for silver deposition of the invention contains silver ions as well as at least one Cu(I) complexing agent selected from the group comprising compounds having the structural element I:

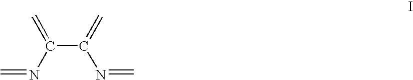

The Cu(I) complexing agent in the acidic solution of the invention, which has the structural element I, can preferably belong to the group of the ferroine compounds. In this case, the complexing agent has the afore mentioned structural element I. The complexing agent may possibly also belong to the cuproine group. In this case, the afore mentioned structural element I is extended as indicated herein after: 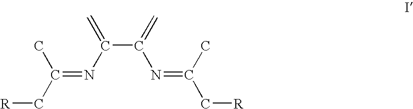
wherein R may be hydrogen or alkyl, aryl, acyl or any other organic moiety.

In some cases, the complexing agent belongs to the terroine group, the compounds of which have the following structural element I″ which may be present in two mesomeric forms:

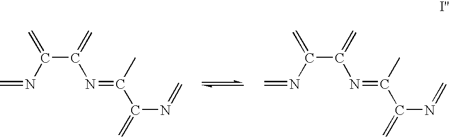

The compounds having the structural element I more specifically have one of the following general structural formulae II or II′: 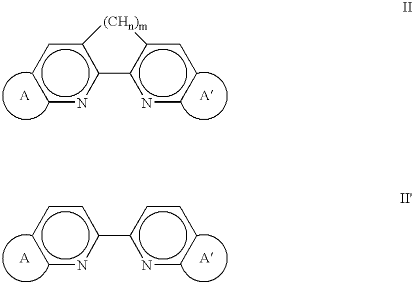
wherein
(CHₙ)ₘ is a hydrocarbon bridge, with n and m being each independently 0 or 1 or 2 and
aromatic rings A and A′ that are condensed with the base member C₅N—NC₅ are possibly provided (in one embodiment of the invention, no rings are condensed with the base member in the structural formulae II and II′ such as in the case of 2,2′-bypyridine, the structural formulae of these compounds being 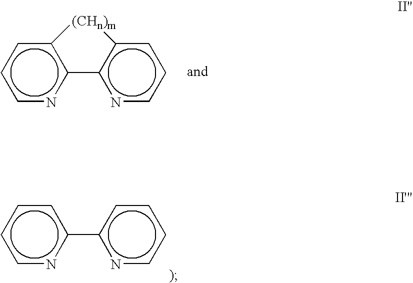
if m=0, there is no bond between the 6- and 6′-C atoms of the C₅N base members such as in the case of 2,2′-bipyridine (cf. compounds with structural formulae II′ and II″′);
the C₅N- and (CHₙ)ₘ-moieties being unsubstituted or substituted with one or more substituents, substituents being alkyl, aryl, acyl, carboxyl, hydroxy, alkoxy, halogen, amido.

In the structural formulae II and II″, (CHₙ)ₘ preferably is an ethenyl group like in the case of 1,10-phenanthroline. Further, the rings A and A′ can represent benzene rings that are condensed with the base member C₅N—NC₅.

The acidic solution and the method are perfectly suited for coating copper surfaces with a tightly adherent, bright silver layer. The layer preferably has a thickness of less than 1 μm, more specifically ranging from 0.2 to 0.5 μm. This value however depends, among others, on the surface structure of the copper surfaces and on the composition of the solution of the invention. The rougher the copper surfaces, the thicker the silver layers can be formed. The silver layer formed is continuous and non-porous and thus ensures that the printed circuit boards treated in this manner can be soldered and bonded without any problem and that the connecting pins of electrical components can be readily mechanically pressed into the through-plated holes provided in the printed circuit board. Moreover, printed circuit boards that have already been contacted with liquid solder can be soldered again, to repair the boards for example.

Moreover, the boards provided with such silver layers meet all of the requirements usually placed on the printed circuit technique. More specifically, the demands placed upon sufficient solder wetting, also after ageing under diverse conditions (see Table 1), are met. Also, the silver layers make it possible to form electrical contact areas for producing switches and plug contacts.

Comprehensive tests showed that the baths described in DE 100 50 862 A1 have a tendency to show precipitates after a short period of operation. It has been assumed that these precipitates are correlated with the color changes that have been observed in the deposited silver layer. These precipitates possibly are copper containing deposits which possibly contain the anti-tarnishing agents added to the bath. Not wishing to be bound by theory, these precipitates may be hardly soluble copper compounds of the anti-tarnishing agents. Said compounds could for example be formed by copper ions (for example Cu⁺) formed from dissolution during the charge transfer reaction, said copper ions reacting with the anti-tarnishing agents contained in the bath. This more specifically applies to benzotriazole which, together with copper, forms a complex that is little soluble in water. It is possible that such agglomerates of the complex also form in the Helmholtz double layer on the surface that is intended to be coated. Said agglomerates could then be incorporated in the silver layer during silver deposition. If this were the case, the change in color of the silver layer could be the result of the incorporation of these colored complexes.

As the silver layers formed during the plating procedure provide a continuous and non-porous coating on the copper surfaces, the thus protected copper surfaces have good soldering properties even after a fairly long storage time under test conditions using humidity and/or heat for example under which oxide layers easily form although the thickness of the layers is preferably less than 1 μm. As a result thereof it is possible to store copper surfaces on printed circuit boards that have been pre-treated in this way after manufacture of the strip conductors prior to mounting the electrical components to said printed circuit boards. As a result thereof, both the surface areas of the bores and the pads serving to electrically fasten the electronic components, and possibly the strip conductors as well, are protected. Prior to silver-plating, the strip conductors are however usually coated with a solder resist that covers the printed circuit board except for those regions in which electrical components are intended to be contacted. Accordingly, the layer of solder resist is usually at first applied to the outer sides of the printed circuit board where it is patterned and a silver layer is next deposited onto the exposed copper areas.

The acidic solution of the invention preferably contains at least one Cu(I) complexing agent, selected from the group comprising 2,2′-bipyridine, 1,10-phenanthroline, 2,6-bis-[pyridyl-(2)]-pyridine, 2,2′-biquinoline (cuproine), 2,2′-bipyridine-5-carboxylic acid, 2,2′-bipyridine4,4′-dicarboxylic acid and 4,7-dihydroxy-1,10-phenanthroline.

The concentration of the at least one Cu(I) complexing agent preferably ranges from 10 to 500 mg/l, preferably from 50 to 100 mg/l and more specifically from 20 to 30 mg/l.

The silver bath contains the silver ions preferably in the form of a silver complex. The bath may for example contain a silver halogen complex (AgClₙ₊₁ⁿ⁻), more specifically a bromine complex (AgBr₂⁻, AgBr₃²⁻, AgBr₄³⁻). As a matter of course, other complexes such as silver chlorine or silver iodine complexes may also be utilized. To produce these complexes, the corresponding silver(I) ions and halide ions are brought to react together by for example blending a silver(I) salt with a halide salt in a solution. Depending on the molar conditions of the silver(I)-ion compound and of the halide compound, complex anions form in the preferably aqueous solution in accordance with the following equation B:
AgX+nX⁻→AgXⁿ⁻ₙ₋₁ B
wherein X⁻ is a halide ion. The stability of the complexes increases in the sequence Cl<Br<I. In the case of the halogen complexes, the complex anions preferably forming are AgCli₂⁻, in the case of the bromine complexes, the complex anions are AgBr₂⁻ and AgBr₃²⁻. To produce the halogen complexes, silver alkane sulfonate, more specifically silver methane sulfonate, silver acetate or silver sulfate can be mixed in the aqueous bath solution with the alkali or earth alkali halides or with the hydrogen halides in a stoichiometric ratio (e.g., 0.01 mol of Ag⁺ for 2 to 3 mol of halide), the complex anions forming thereby. These anions preferably also form when mixing the two species when these are not mixed in the stoichiometric ratio. A source of halide ions is preferably utilized in excess. For most applications, the silver concentration in the bath is adjusted to approximately 1 g/l. The concentration may range from 0.1 to 20 g/l.

In utilizing silver halide complex compounds that are brought into solution in an excess of dissolved alkali halide, stable silver deposition bath solutions in water are formed. In such a solution, the amount of free silver ions (Ag⁺) is reduced so much that stable silver layers with a high bonding strength are formed by way of the transfer reaction between copper metal and silver ions. The solutions are stable to acids so that the silver layers may also be deposited when the pH of the bath is strongly acid.

The pH of the bath is adjusted to a value ranging from 0 to 7, preferably from 4 to 6, by means of pH adjusting means (acids or bases) such as the hydrogen halides corresponding to the complex anions, i.e., hydrochloric acid, hydrobromic acid and/or hydriodic acid, or with a caustic alkali or carbonate.

Instead of, or in addition to, the hydrogen halides, the solution may contain other acids. In principle, all of the known mineral acids and/or organic acids as well as the mixtures thereof are suited.

In order to make certain that the printed circuit boards can be repeatedly contacted with liquid solder without the solderability being affected thereby, the silver layers formed must be as continuous and non-porous as possible, since otherwise one single soldering procedure may cause oxide layers to form on the exposed areas of the copper surfaces. In this case, the ability of the overall surface to be wetted by the solder would be considerably affected. Normally hence, the deposited silver layers must be relatively thick in order to meet the requirements mentioned. In the present case however, silver layers of 0.2 to 0.3 μm thick suffice.

To this purpose, the acidic solution of the invention may also contain one Cu(II) complexing agent. The complexing agents of preference belong to the group comprising polyamines, amino carboxylic acids and amino phosphonic acids. Ethylene diamine, alanine diacetic acid, amino trimethylene phosphonic acid, diethylene triamine pentamethylene phosphonic acid and 1-hydroxyethylene-1,1-diphosphonic acid are particularly suited.

In using the Cu(II) complexing agent, the formation of gaps and pores in the silver layer is further reduced. As reaction products from the copper originating from the charge transfer reaction particularly gather in the pores of the silver layer, the transfer reaction is presumably hindered. The Cu(II) complexing agent obviously serves to better solubilize the Cu(II) ions so that the charge transfer reaction is facilitated.

In adding the Cu(I) complexing agent to the acidic solution of the invention, the plating rate is reduced. If, for example, in depositing silver by way of a charge transfer reaction within 5 minutes at a temperature of 50° C. a silver layer of 0.6 μm thick on copper is obtained when the solution does not contain any Cu(I) complexing agent, the thickness is reduced to 0.4 μm after the addition of 5 mg of 2,2′-bipyridine for example. In adding the Cu(I) complexing agent, the aspect of the layer is enhanced and the tendency to form dendrites is reduced. In using the acidic solution of the invention, even light microscope examination shows uniform crystalline silver layers without any dendrites.

However, the bonding strength and solderability of such layers proved insufficient for use in the industry of printed circuit boards. To this purpose, the concentration of the Cu(I) complexing agent is increased. For, if the amount of 2,2′-bipyridine is increased to 10 to 100 mg/l, the silver layers obtained are tightly adherent. Light microscope examination with a magnification of 500 to 1000.times. shows a compact-grained layer, dendrites cannot be observed under these conditions. Microscope examination does not show any pores so that no exposed copper areas are to be seen. However, under these conditions, the average thickness of the silver layer is further reduced to 0.2 to 0.3 μm. Thus obtained silvery bright silver layers still pass the necessary solder tests without any problem even after having been subjected to dry heat and to a vapor test. The necessary storing properties are thus guaranteed. An optical discoloration of the silver layer after the ageing tests described herein above was not observed; even after ageing the layers were bright and silvery.

The acidic solution of the invention can additionally contain at least one surface-active agent, a polyglycol ether for example such as a polyethylene glycol, a polypropylene glycol and/or a copolymer or a block polymer of ethylene glycol and propylene glycol.

Preparation of the solution of the invention can proceed as follows:

A silver salt is dissolved in water and the solution is then heated to accelerate the formation of the complex anion. Next, an alkali halide and an aqueous hydrogen halide solution are for example added by stirring. The order of addition can also be reversed. A precipitate of the silver halide first forms thereby. But the precipitate dissolves again as the halide is further added, the complex anion, which is soluble in an aqueous solution, forming thereby.

Silver already deposits from the baths according to the invention onto the copper surface at a temperature below 20° C. The deposition rate is influenced by the temperature of the solution and the silver ion concentration. The operating temperature is preferably adjusted in a range from 35 to 50° C.

The thickness required for the silver layer is achieved in a very short time. Within 1 to 10 minutes, a silver layer of 0.2 to 0.5 μm thick is deposited. Therefore, this solution is perfectly suited for horizontal printed circuit board production. The choice of the acid and of the pH also determine the plating rate.

To carry out the method of depositing silver layers onto metal surfaces by way of a charge transfer reaction, the acidic solution of the invention is prepared and the metal surfaces are brought into contact therewith. Usually, the printed circuit boards are suspended vertically and immersed into the tanks provided for the purpose and filled with the processing fluid (immersion technique). As an alternative, processing plants may be utilized in which the boards are held in horizontal position and through which they are conveyed in horizontal direction (horizontal technique). In this case, the processing fluid is delivered through nozzles (spray nozzles, jet nozzles, flow nozzles) to one or both sides of the surfaces of the boards conveyed and guided by means of appropriate conveying means (rolls, clamps). In the horizontal plants, the boards can also be conveyed through the plant in vertical position in horizontal direction of transport.

Prior to silver-plating the copper surfaces, the areas are preferably cleaned and roughened in order to enhance the bonding strength of the silver layer on the support. An acidic processing solution containing surface-active agents may for example be utilized for cleaning. This is not absolutely necessary though if the boards were handled properly prior to silver-plating.

If necessary, the boards are then rinsed to remove residual cleaning fluid from the copper surfaces.

Thereafter, the copper surfaces may be roughened with a chemical etch solution. For this purpose, etch solutions in use in the printed circuit board technique may be utilized such as an acidic solution of sodium peroxo disulfate or an etch solution of copper(II) chloride. After the treatment with the etch solution, the board is usually rinsed once more prior to contacting it with the acidic silver plating solution.

Once silver-plating is completed, the board is generally rinsed again and then usually dried.

The following examples serve to explain the invention in closer detail.

### COMPARATIVE EXAMPLE 1

320 g of sodium bromide were dissolved in 1 liter of water. Then, 3.6 ml of a 38 percent (w/w) solution of silver methane sulfonate were added. Upon dissolution of the precipitates, 30 ml of a 50 percent (w/w) solution of amino trimethylene phosphonic acid were added and the pH was adjusted to 5.5 using caustic soda lye. The clear solution was heated to 50° C.

A printed circuit board was etched using an acidic solution of sodium peroxo disulfate, rinsed and then immersed for 3 min into the silver bath. Upon completion of the plating process, the thickness of the silver layer was 0.3 μm.

### COMPARATIVE EXAMPLE 2

1.0 g/l of benzotriazole was additionally added to the bath prepared according to comparative example 1. The printed circuit board was treated like in comparative example 1.

After 3 minutes treatment, the thickness of the silver layer was 0.2 μm.

### EXAMPLE 3

30 mg of 2,2′-bipyridine were added to a bath prepared according to comparative example 1. A printed circuit board was pre-treated as described in comparative example 1 and then silver plated in the solution of the invention.

A silver layer of 0.25 μm thick deposited within 5 minutes.

### EXAMPLE 4

10 mg of o-phenanthroline were added to a bath prepared according to comparative example 1. A printed circuit board was pre-treated as described in comparative example 1 and then coated with silver in the solution of the invention for 7 minutes.

The thickness of the applied silver layer amounted to 0.25 μm.

The results of solder tests after different ageing conditions are listed in Table 2.

TABLE 1
Ageing tests

| Test | Test conditions |
|---|---|
| Dry heat | 4 h/155° C. |
| Vapor test | 4 h/98-100° C. |

TABLE 2
Solderability of the printed circuit boards

| (Comparative) | After Deposition | | Dry Heat | | Vapor test | |
|---|---|---|---|---|---|---|
| Example | T [sec]*) | F [mN/mm]**) | T [sec]*) | F [mN/mm]**) | T [sec]*) | F [mN/mm]**) |
| 1 | 0.20 | 0.15 | 0.38 | 0.10 | 0.60 | 0.07 |
| 2 | 0.18 | 0.15 | 0.31 | 0.14 | 0.63 | 0.08 |
| 3 | 0.15 | 0.17 | 0.18 | 0.17 | 0.18 | 0.18 |
| 4 | 0.15 | 0.17 | 0.14 | 0.17 | 0.15 | 0.18 |

*)Wetting time T
**)Wetting force F

1. An acidic solution for silver deposition through charge transfer reaction containing silver ions and at least one cu(I) complexing agent, wherein the Cu(I) complexing agent is selected from the group consisting of compounds having the structural element I

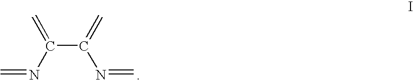

2. The acidic solution claim 1, wherein the compounds having the structural element I have one of the following general structural formulae II or II′: 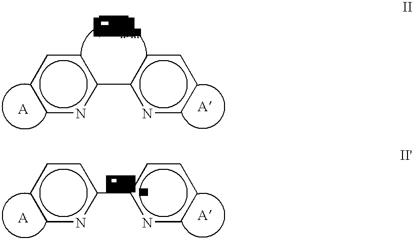
wherein
(CHₙ)ₘ is a hydrocarbon bridge, with n and m being each independently 0 or 1 or 2, and the rings A and A′ being, in the general chemical formulae II and II′, aromatic rings that are condensed with the base member C₅N—NC₅.

3. The acidic solution according to any one of the preceding claims, wherein (CHₙ)ₘ is an ethenyl group.

4. The acidic solution according to any one of the preceding claims 1-2, wherein the rings A and A′ are benzene rings that are condensed with the base member C₅N—NC₅.

5. The acidic solution according to any one of the preceding claims 1-2, wherein the at least one Cu(I) complexing agent is selected from the group consisting of 2,2′-bipyridine, 1,10-phenanthroline, 2,6-bis-[pyridyl-(2)]-pyridine, 2,2′-biquinoline, 2,2′-bipyridine-5-carboxylic acid, 2,2′-bipyridine-4,4′-dicarboxylic acid and 4,7-dihydroxy-1,10-phenanthroline.

6. The acidic solution according to any one of the preceding claims 1-2, wherein the concentration of the at least one Cu(I) complexing agent ranges from 10 mg/l to 500 mg/l.

7. The acidic solution according to any one of the preceding claims 1-2, wherein the silver ions are contained in the form of halogen complexes.

8. The acidic solution according to any one of the preceding claims 1-2, wherein the silver ions are contained in the form of bromine complexes.

9. The acidic solution according to any one of the preceding claims 1-2, wherein at least one Cu(II) complexing agent is additionally contained, the Cu(II) complexing agent being selected from the group consisting of ethylene diamine, alanine diacetic acid, amino trimethylene phosphonic acid, diethylene triamine pentamethylene phosphonic acid and 1-hydroxyethylene-1,1-diphosphonic acid.

10. The acidic solution according to any one of the preceding claims 1-2, wherein the pH of the solution ranges from 4 to 6.

11. A method of depositing silver layers onto metal surfaces through charge transfer reaction comprising the following method steps:
(a) preparing the acidic solution according to any one of claims 1-2;
(b) contacting the metal surfaces with the acidic solution.

12. The method of claim 11, wherein the metal surfaces are copper surfaces.

13. The method according to claim 11, comprising cleaning and/or etching the metal surfaces prior to contacting them with the acidic solution.

14. The method of claim 13, wherein the metal surfaces are copper surfaces, the method comprising etching the copper surfaces using a solution containing a peroxo compound selected from the group consisting of alkali peroxo disulfate, alkali caroate or hydrogen peroxide.

15. The method according to claim 11, comprising applying the silver layers onto the metal surfaces through charge transfer reaction in a horizontal conveyorized plating process.

16. The method according to claim 11, comprising forming protective silver layers on the metal surfaces, more specifically on printed circuit boards, for the purpose of subsequently performing a soldering process, a bonding process, a press-fit securement and/or of establishing electrical contacts.
